(19) United States
(12) Patent Application Publication
(10) Pub. No.: US 2003/0116434 A1
(43) Pub. Date: Jun. 26, 2003

(54) Package of multilayer film electrode web for electrolyte slide

(76) Inventors: Masaaki Terashima, Saitama (JP); Takeshi Igarashi, Saitama (JP); Osamu Seshimoto, Saitama (JP); Sadao Yamada, Saitama (JP)

Correspondence Address: Reed Smith, LLP, Patent, Trademark And Copyright Matters, 599 Lexington Avenue, New York, NY, 10022, US

(21) Appl. No.: 10/303,634

(22) Filed: Nov. 25, 2002

(30) Foreign Application Priority Data
Nov. 26, 2001 (JP) 2001-358618

(51) Int. Cl. G01N 27/26

(52) U.S. Cl. 204/418

(57) ABSTRACT

The package of a multilayer film electrode web for an electrolyte slide of the invention comprises a packaging film web and the multilayer film electrode web superposed to each other, wherein the multilayer film electrode web is provided with an ion-selective membrane at central portion of the web, wherein the packaging film web is provided with raised portions on both side ends having a height higher than the thickness of the ion-selective membrane, wherein the ion-selective membrane is arranged to exist between the raised portions on both side ends, which protects the ion-selective membrane from being damaged by a foreign body.

### BACKGROUND OF THE INVENTION

This invention relates to a package of a web of a multilayer film electrode for an electrolyte slide which is a device for measuring an ionic activity, which renders the ion-selective membrane not to be damaged.

Electrolyte slides using sheet-shaped ion-selective electrodes are used for analyzing blood components, etc. A device for measuring an ionic activity using an ion-selective membrane, especially an electrolyte slide using sheet-shaped ion-selective electrodes, is effective for measuring an ionic activity of a liquid sample rapidly, conveniently and accurately. Such a device is disclosed in West Germany Patent No. 2,722,617, etc.

An electrolyte slide disclosed in JP 58-211648A and JP 62-9264 can measure plural items of ionic activity simultaneously by spotting once a liquid sample and a reference solution.

A structure of the electrolyte slide is illustrated in FIG. 6. The electrolyte slide 40 is composed of an upper frame 41, a lower frame 42 and a double face adhesive tape 45.

The upper frame 41 is provided with a bridge groove 47 and two spotting holes 48 on the upper side, and three recesses 49 on the underside. The bridge groove 47 for placing a bridge 46 is formed passing through two spotting holes 48, and both ends are widened in V-shape. One of the spotting hole 48 is for supplying a liquid sample, and the other hole 48 is for supplying a reference solution. The bridge 46 is a twisted string made of polyester, and connects both spotting holes 48. The recesses 49 are shallow channel-shaped, and are for placing multilayer film electrodes 43, respectively.

The lower frame 42 is provided with two shallow rectangular shaped recesses 50 in the cross direction against the recesses 49 of the upper frame 41 for placing distribution materials 44, and three pairs of terminal holes 51 for electrically connecting to each electrode 43 formed on both sides of the lower frame 42.

The double face adhesive tape 45 joined the upper frame 41 and the lower frame, and is provided with two spotting holes 52 and six liquid supply holes 53. The spotting holes 52 meet the spotting holes 48 of the upper frame 41, respectively, and the liquid supply holes 53 meet the multilayer film electrodes 43 and the distribution materials 44.

The electrolyte slide 40 is assembled by adhering the lower frame 42 containing the distribution materials 44 fitted into the recesses 50 to one side of the double face adhesive tape 45, and by adhering the upper frame 41 containing the multilayer film electrodes 43 fitted into the recesses 49.

Incidentally, the multilayer film electrode is composed of a support made of polyethylene terephthalate resin or the like, a halogenated silver layer covered at the central portion of the silver layer, and and ion-selective membrane laminated onto the halogenated portion.

The ion-selective membrane has adhesive property, and is easily damaged by contracting a foreign body. Such a damage tends to occur during storing the multilayer film electrode web and assembling an electrolyte slide.

### SUMMARY OF THE INVENTION

An object of the invention is to provide a package of a multilayer film electrode web capable of storing the multilayer film electrode web and assembling an electrolyte slide without damage of the ion-selective membrane.

The present invention has solved the above problems, and provides a package of a roll of a multilayer film electrode web for an electrolyte slide which comprises a packaging film web and the multilayer film electrode web superposed to each other, wherein the multilayer film electrode web is provided with an ion-selective membrane at central portion of the web, wherein the packaging film web is provided with raised portions on both side ends having a height higher than the thickness of the ion-selective membrane, wherein the ion-selective membrane is arranged to exist between the raised portions on both side ends.

In the package of a roll of a multilayer film electrode web for an electrolyte slide of the invention, the multilayer film web is fundamentally supported by the raised portions of the packaging film web which are contacted with both side ends of the multilayer film web to prevent the damage of the ion-selective membrane.

### BRIEF DESCRIPTION OF THE DRAWINGS

FIG. 1 is a perspective view of a package of a multilayer film electrode web for an electrolyte slide which embodies the invention.

FIG. 2 is a partial perspective view of the packaging film web.

FIG. 3 is a partial perspective view of the multilayer film electrode web.

FIG. 4 is a partial enlarged side view of the packaging film web and the multilayer film electrode web superposed to each other in the roll, and FIG. 5 is a section in the cross direction thereof.

FIG. 6 is an exploded perspective view illustrating the structure of an electrolyte slide.

10 . . . Core

20 . . . Packaging film web

21 . . . Flat portion

22 . . . Raised portion

30 . . . Multilayer film electrode web

31 . . . Support

32 . . . Silver layer

33 . . . Ion-selective membrane

40 . . . Electrolyte slide

41 . . . Upper frame

42 . . . Lower frame

43 . . . Multilayer film electrode

44 . . . Distribution member

45 . . . Double face adhesive tape

46 . . . Bridge

47 . . . Bridge groove

48 . . . Spotting hole

49 . . . Recess

50 . . . Recess

51 . . . Terminal hole

52 . . . Spotting hole

53 . . . Liquid supply hole

### DETAILED DESCRIPTION OF THE INVENTION

The multilayer film electrode web has a structure comprising a support, silver layer, halogenated silver layer, electrolyte layer and ionselective layer in this order.

The support is made of a plastic including polyethylene terephthalate, polyethylene naphthalate, cellulose triacetate, polyvinyl chloride, polyvinylidene chloride, polystyrene, ABC resin, polyethylene, polypropylene, polyvinyl acetate, vinyl chloride-vinyl acetate copolymer. The support has, in general, a thickness of 100 to 250 μm, particularly 150 to 200 μm, a width of 5 to 40 mm, particularly 10 to 30 mm, and a length of 2 to 20 mm, particularly 2 to 10 mm.

The electrode layer is made of silver layer, halogenated silver layer, electrolyte layer, and has a thickness of 0.1 to 10 μm, particularly 0.5 to 5 μm, and a width of 5 to 40 mm, particularly 10 to 30 mm.

The ion-selective membrane comprises an ionophore, such as valinomycin (K+) or monensin (Na+), a plasticizer, such as dioctyl phthalate or dioctyl sebacate, and a binder, such as PVC or vinyl chloride-vinyl acetate copolymer, and is applicable to an ion of hydrogen (pH), Na, K, Cl, Ca, Li, Mg, carbonate, bicarbonate, etc. The ion-selective membrane has a thickness of 1 to 100 μm, particularly 10 to 50 μm, and a width of 5 to 40 mm, particularly 10 to 30 mm.

The packaging film web is made of a plastic selected from listed ones for the support in the multilayer film electrode as well as paper, etc., and has, in general, a thickness of 50 to 300 μm, particularly 100 to 250 μm, a width identical with or slightly longer than the support in the multilayer film electrode by 5 to 40 mm, particularly 10 to 30 mm, and a length identical with or slightly longer than the multilayer film electrode web.

In the invention, the packaging film is provided with raised portions on both side ends. The form of the raised portions may be any form capable of supporting the multilayer film electrode, and may be continuously or discontinuously contacted with the multilayer film electrode. Illustrative of continuously contacting forms have a cross section of square, trapezoid, triangle or the like, and illustrative of discontinuously contacting forms are sawtooth, wave, row of triangles, row of trapezoids, row of squares, etc. The raised portions may be formed by lending the side edge portions, e.g. by knuring, or adhering a separate body.

The height of the raised portions is higher than the thickness of the ion-selective membrane so that the ion-selective membrane does not touch the reverse side of the packaging film, preferably higher than the thickness of the ion-selective membrane by 0.5 mm or more, more preferably 1.0 mm or more. A suitable width of the raised portions is 5 to 40 mm, preferably 10 to 30 mm.

### EXAMPLES

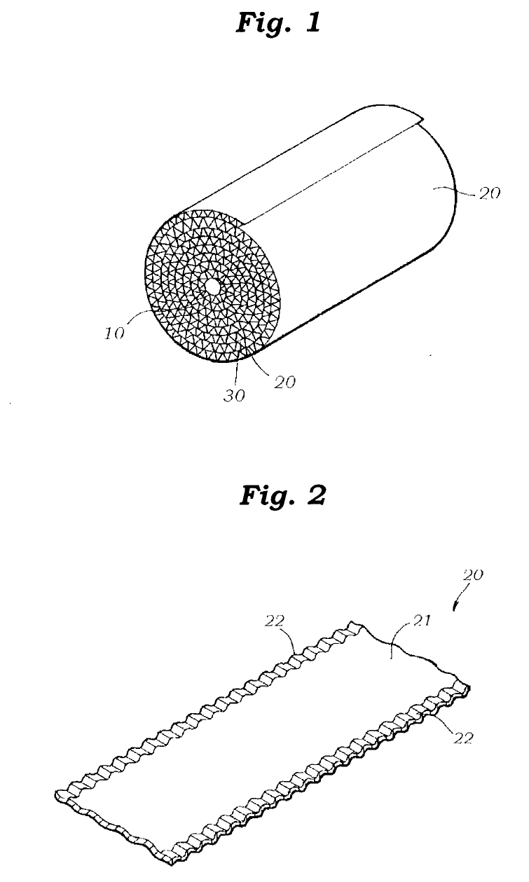

An example of the package of a roll of a multilayer film electrode web for an electrolyte slide of the invention is illustrated in FIGS. 1-5.

In FIG. 1, a packaging film web 20 and a multilayer film electrode web 30 are superposed, and wound around a core 10 to form a roll.

The diameter of the core is 150 mm.

The packaging film web 20 is made of plastic having a thickness of 50 μm, a width of 300 mm, and a length of 150 m. As shown in FIG. 2, the center of the packaging film web 20 is a flat portion 21, and both side edges of one surface of the packaging film web are knurled each in a width of 24 mm to form sawtooth-shaped raised portions 22 in a height of about 2 mm from the surface of the flat portion 21 so as to be higher than the thickness of the ion-selective membrane.

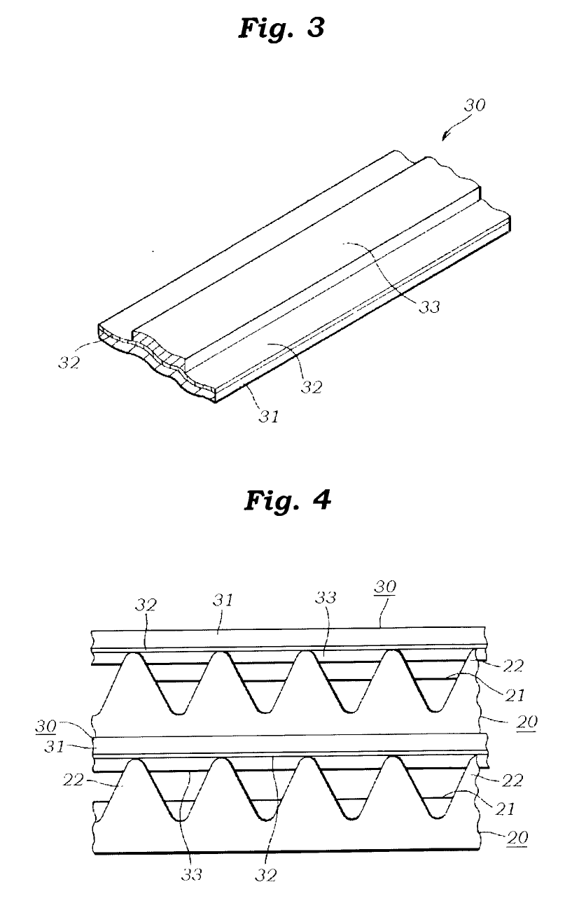

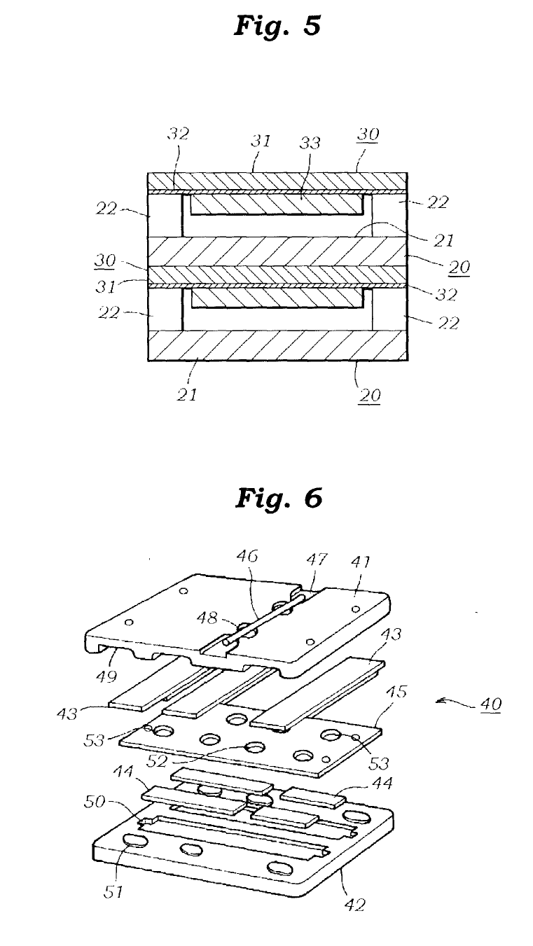

The multilayer film electrode web 30 is, as shown in FIG. 3, composed of a support 31 made of polyethylene terephthalate about 200 μm in thickness and 24 mm in width, a silver layer 32 about 8000 Å provided over the entire surface of one side of the support 31, and an ion-selective membrane 33 about 35 μm in thickness and 12 mm in width. The central portion (the portion except both side ends) of the silver layer 32 was provided with halogenation treatment, and the ion-selective membrane 33 is provided thereon.

In the wound state of the multilayer film electrode web 30 together with the packaging film web 20 around the core 10, as shown in FIGS. 4 and 5, the multilayer film electrode web 30 is superposed on the packaging film web 20 so that the raised portion 22 side of the packaging film web 20 faces the ion-selective membrane 33 side of the multilayer film electrode web 30. As a result, both side ends of the multilayer film electrode web 30 meet the raised portions 22 of the packaging film web 20, respectively, and the ion-selective membrane 33 is allocated in the space surrounded by the raised portions 22 and the flat portion 22 with a distance.

Accordingly, the surface of the ion-selective membrane 33 is not in contact with the flat portion 21, and a foreign body does not touch it. Thus, the ion-selective membrane can be kept under good conditions while storing and assembling an electrolyte slide.

1. A package of a roll of a multilayer film electrode web for an electrolyte slide which comprises a packaging film web and the multilayer film electrode web superposed to each other, wherein the multilayer film electrode web is provided with an ion-selective membrane at central portion of the web, wherein the packaging film web is provided with raised portions on both side ends having a height higher than the thickness of the ion-selective membrane, wherein the ion-selective membrane is arranged to exist between the raised portions on both side ends.

2. The package of claim 1 wherein the raised portions are knurls.
